(19) United States
(12) Patent Application Publication
(10) Pub. No.: US 2018/0139428 A1
(43) Pub. Date: May 17, 2018

(54) DISPLAY APPARATUS FOR RECEIVING DATA STREAM FROM EXTERNAL DEVICE, AND METHOD FOR CONTROLLING THE SAME

(71) Applicant: CANON KABUSHIKI KAISHA, Tokyo (JP)

(72) Inventor: Tomoaki Komiyama, Kamakura-shi (JP)

(21) Appl. No.: 15/801,165

(22) Filed: Nov. 1, 2017

(30) Foreign Application Priority Data
Nov. 11, 2016 (JP) 2016-220902

(51) Int. Cl. H04N 9/31; H04N 5/268; H04N 17/04

(52) U.S. Cl. CPC H04N 9/3191; H04N 9/3185; H04N 17/04; H04N 5/268

(57) ABSTRACT

One or more display apparatuses, control methods and storage mediums for use with same are provided herein. A clock is generated from a data stream received from an external device. Symbol data is extracted from the data stream at a timing based on the clock. If any of bit lock of the clock by a generation unit, symbol lock by an extraction unit, and channel equalization, for the video data stream received from the external device fails, a display image is changed from an image based on the data stream to a predetermined image.

### BACKGROUND OF THE INVENTION

### Field of the Invention

The present disclosure relates to one or more embodiments of a display apparatus for receiving a data stream from an external device, and a method for controlling the same.

### Description of the Related Art

A display apparatus with a high resolution of 4K2K (3840 pixels×2160 pixels) or SHV (7680 pixels×4320 pixels) includes a display interface for inputting high-resolution video signals from an external device. Examples of standards of the display interface supporting high resolution video signals include DisplayPort (registered trademark. Hereinafter DP) and HDMI (registered trademark).

In these standards, when a device (source device) that transmits video signals to a display apparatus and the display apparatus (sink device) are connected to each other, the sink device notifies the source device of information on the sink device as data called Extended Display Identification Data (EDID). The EDID stores, for example, the model name of the sink device, a combination of a supported resolution and refresh rate, a bit depth, and a pixel encoding format).

The EDID is referred to and accordingly the source device such as a computer device can transmit an appropriate video signal according to the capability of the sink device. Moreover, in the DP standard, a procedure called link training is performed between the source device and the sink device to determine the transmission rate of video data, the number of transmission lines (lanes), and the like.

However, a video signal that cannot be received or displayed by the sink device may be transmitted due to the failure of the source device. For example, a video signal with a resolution that is not supported by the sink device may be transmitted, or video signals of an amount exceeding a transmission bandwidth determined by a determined transmission rate and number of transmission lines may be transmitted. In this case, the sink device cannot receive and display a video signal normally, and distorted video is displayed.

As a measure taken by a display apparatus (sink device) in a case where a received video signal cannot be displayed normally, it is known to change the contents of the EDID and transmit it to a source device (Japanese Patent Laid-Open No. 2009-33446) or to display a black screen or an error message (Japanese Patent Laid-Open No. 2012-226310).

However, when, for example, video signals of an amount exceeding a transmission bandwidth (a transmission rate and the number of transmission lines) determined by link training are being transmitted, the display cannot be returned to normal unless the transmission bandwidth is reset. The resetting of the transmission bandwidth requires link training to be performed again. Even if the EDID is changed as in Japanese Patent Laid-Open No. 2009-33446, the distorted display cannot be interrupted.

Moreover, if the format (the resolution and the refresh rate) of a video signal is not supported by the display apparatus in the method of Japanese Patent Laid-Open No. 2012-226310, a black screen is displayed to enable the interruption of the distorted display. However, it is not possible to deal with a case where video signals of an amount exceeding the transmission bandwidth are transmitted in a format supported by the display apparatus; therefore, the distorted display cannot be interrupted.

### SUMMARY OF THE INVENTION

The above-mentioned issues are overcome, in accordance with one or more aspects of the present disclosure, by one or more embodiments of a display apparatus including: a generation unit configured to generate a clock from a data stream received from an external device; an extraction unit configured to extract symbol data from the data stream at a timing based on the clock; an output unit configured to output a display image based on the data stream; a detection unit configured to detect failure of any of bit lock of the clock by the generation unit, symbol lock by the extraction unit, and channel equalization, for the data stream received from the external device; and an instruction unit configured to instruct the output unit to change the display image to a predetermined image in response to the detection.

According to other aspects of the present disclosure, one or more additional display apparatuses, one or more control methods, and one or more storage mediums for use therewith are provided. Further features of the present disclosure will become apparent from the following description of exemplary embodiments (with reference to the attached drawings).

### BRIEF DESCRIPTION OF THE DRAWINGS

FIG. 1 is a block diagram illustrating an example of the functional configuration of a projector being an example of a display apparatus according to at least one embodiment of the present disclosure.

FIG. 2 is a flowchart related to the overall operation of the projector of FIG. 1.

FIG. 3 is a diagram illustrating the relationship between a symbol and data in an 8B10B encoding format.

FIG. 4 is a block diagram illustrating an example of the functional configuration of a video input unit 110 of FIG. 1.

FIG. 5 is a flowchart related to a video signal monitoring process in at least a first embodiment.

FIG. 6 is a flowchart related to a video signal monitoring process in a modification of at least the first embodiment.

FIG. 7 is a flowchart related to a video signal monitoring process in at least a second embodiment.

FIG. 8 is a diagram illustrating examples of combinations of a video format and a transmission condition supported by the projector according to at least one embodiment.

### DESCRIPTION OF THE EMBODIMENTS

Illustrative embodiments of the present disclosure are described in detail hereinafter with reference to the drawings. At least one configuration where the present invention is applied to a projector is described below. However, the projector is a mere example of a display apparatus to which the present invention can be applied. One or more features of the present invention can be generally applied to a display apparatus that generates (recovers) a clock for receipt (sampling) of data from a video data stream. A projector that is compliant with the DisplayPort standard is described here as an example of such a display apparatus. However, the display apparatus may be compliant with other standards such as HDMI.

### First Embodiment

(Configuration of the Projector)

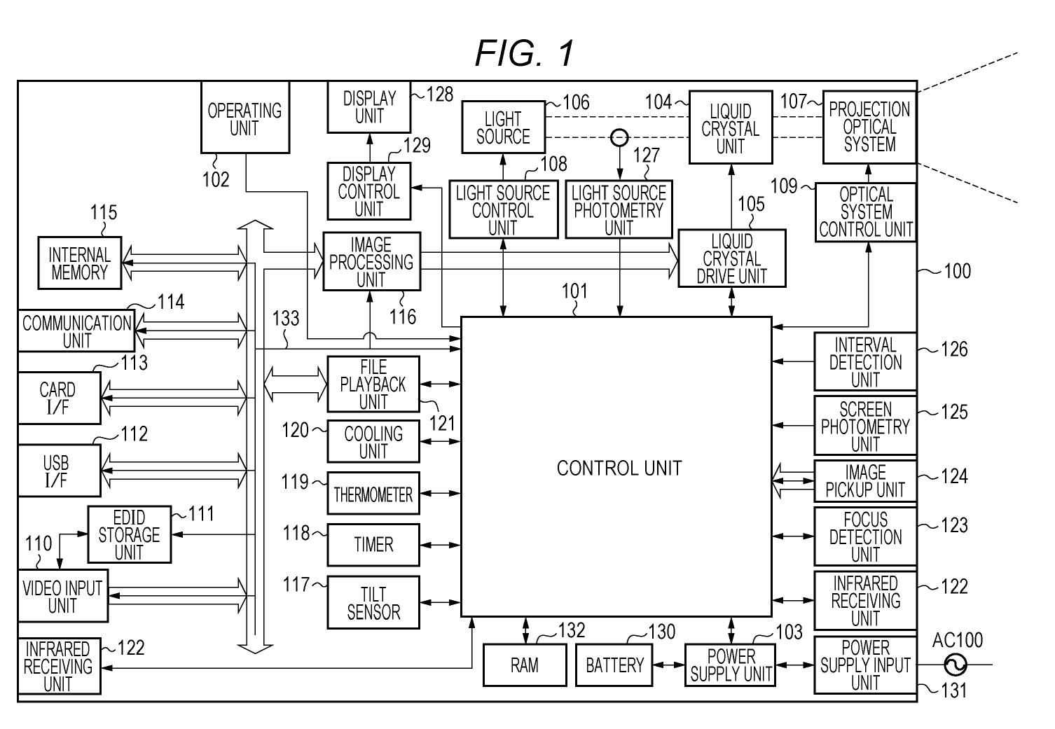

FIG. 1 is a block diagram illustrating an example of the functional configuration of a liquid crystal projector (hereinafter simply referred to as the projector) 100 according to the embodiment. A control unit 101 is, for example, one or more microprocessors. The control unit 101 reads a program stored in an internal memory 115 into a RAM 132 and executes the program. Accordingly, the operation of each block of the projector 100 is controlled to achieve each function of the projector 100. The control unit 101 is connected directly or by a bus 133 to each block to enable communication with each block. An operating unit 102 is an input device, such as a button, a switch, or a touchscreen, which is provided to a housing of the projector 100. A power supply unit 103 controls supply of a predetermined voltage generated by a power supply input unit 131 from a commercial power supply to each block of the projector 100.

A liquid crystal unit 104 includes, for example, one or three liquid crystal panels. In the embodiment, the display resolution of the liquid crystal unit 104 is assumed to be 3840 pixels×2160 pixels. A liquid crystal drive unit 105 drives the liquid crystal panel of the liquid crystal unit 104 on the basis of an image signal supplied from an image processing unit 116 to display an image on the liquid crystal panel.

The liquid crystal unit 104 is illuminated by a light source 106. An image displayed on the liquid crystal unit 104 is projected by a projection optical system 107 to a screen or the like. A light source control unit 108 controls the light amount of the light source 106. Moreover, the projection optical system 107 includes a lens for adjusting the angle of view and a lens for adjusting the focus. An optical system control unit 109 drives these lenses at the instruction of the control unit 101.

A video input unit 110 is an interface for the projector 100 (a sink device) to receive a video data stream from an external device (a source device) such as a personal computer or media player. In the embodiment, the video input unit 110 includes a connector and a circuit, which are compliant with the DP standard. The video input unit 110 achieves, for example, a function of converting symbol data extracted from a 8B10B encoded video data stream into a signal that can be received by the image processing unit 116, and also a function of detecting the receipt of a video data stream and a 8B10B decoding function. Video signals and image signals, which have been received by the video input unit 110, are supplied to the image processing unit 116.

The DP standard at the present time stipulates a Main Link including lanes 0 to 3 as signal lines, an Auxiliary Channel (AUX-CH), and Hot Plug Detect (HPD). In the DP standard, video and control signals are encoded in the 8B10B encoding format and are transmitted as data streams, and there is no clock signal line. The sink device uses a clock recovery function to recover (generate) a clock bit locked to a video data stream, detects a symbol boundary properly from the video data stream, and extracts symbol data (symbol lock). The Auxiliary Channel is used for transferring EDID between devices, link training, and the like.

An EDID storage unit 111 is, for example, a nonvolatile memory, and stores EDID storing information on the projector 100. When connected to the projector 100 through the video input unit 110, the source device that is compliant with the DP standard acquires the EDID stored in the EDID storage unit 111.

A USB interface (I/F) 112 is an interface for communicating with an external device that is compliant with the USB specification. The external device may be an apparatus that transmits video and image data, an input device such as a pointing device or keyboard, or a storage device.

A card interface (I/F) 113 is an interface that writes and reads a semiconductor memory card. A communication unit 114 is a network interface for communicating with the external device by wired or wireless communication. An internal memory 115 stores a program to be executed by the control unit 101, various setting values, GUI data, and the like. The internal memory 115 may be a nonvolatile memory, or a storage device such as a hard disk or SSD.

A file playback unit 121 has a viewer function of a document file in a predetermined format. The file playback unit 121, for example, opens a document file read from a memory card through the card interface 113, generates an image signal for display, and outputs the image signal to the image processing unit 116.

The image processing unit 116 makes a correction in such a manner that a video signal received from the video input unit 110 or the file playback unit 121 becomes a signal suitable to be displayed on the liquid crystal unit 104. For example, the image processing unit 116 converts the resolution of the video signal in accordance with the display resolution of the liquid crystal unit 104, doubles the number of frames of the inputted video signal for AC driving of the liquid crystal panel, and further applies a correction suitable for display by the liquid crystal panel.

The AC driving of the liquid crystal panel is a driving method that displays by changing the direction of a voltage to be applied to the liquid crystal panel by use of the property of being capable of displaying when the direction of a voltage to be applied to the liquid crystal panel is either the positive direction or the opposite direction. When the liquid crystal panel undergoes the AC driving, the liquid crystal drive unit 105 needs to supply video signals (frames) according to the voltage application directions, one by one. Hence, the image processing unit 116 doubles the number of frames of video signals to generate video signals according to the voltage application directions. The liquid crystal drive unit 105 drives the liquid crystal panel of the liquid crystal unit 104 on the basis of an image signal supplied from the image processing unit 116 to cause the liquid crystal panel to display an image.

Furthermore, the image processing unit 116 can also make a measurement and an analysis of a video signal received through the video input unit 110. For example, the image processing unit 116 measures a timing of a synchronization signal included in the video signal, or the like, and stores it in a storage device that can be read by the control unit 101, such as an internal register or memory. Moreover, the image processing unit 116 can store gray level information of each pixel included in the video signal in, for example, the internal register.

Moreover, the image processing unit 116 can also apply a geometric deformation process, such as trapezoidal distortion correction (keystone correction) process, to the video signal. Keystone correction may be applied automatically by the image processing unit 116 on the basis of a tilt angle obtained by a tilt sensor 117, or may be applied in accordance with an instruction through operation of the operating unit 102. A timer 118 is used to detect the operating times of the projector 100 and each block. A thermometer 119 measures a temperature near the light source 106, a temperature near the liquid crystal unit 104, an outside temperature, and the like, and then notifies the control unit 101 of measurement results.

Infrared receiving units 122 receive an infrared ray from a remote controller or the like of the projector 100, convert the infrared ray into an electrical signal, and output the electrical signal to the control unit 101. The infrared receiving units 122 are mounted at a plurality of points, for example, the front and rear, of the housing of the projector 100.

A focus detection unit 123 detects a distance between the projector 100 and a projection surface (such as a screen) as a projection distance by using, for example, an infrared ray or ultrasonic wave. An image pickup unit 124 captures an image in the direction of the projection surface (normally the optical axis direction of the projection optical system 107). A screen photometry unit 125 measures the amount and luminance of light reflected from the projection surface. A display unit 128 is, for example, an LCD, and displays the state of the projector 100, an alert, a GUI, and the like in accordance with control by a display control unit 129. A battery 130 is a power supply that is used when the projector 100 is not connected to an external power supply. A cooling unit 120 includes, for example, a heat sink and a fan, and releases the internal heat of the projector 100. The file playback unit 121 generates image data for display from file data at the instruction of the control unit 101. The RAM 132 is used by the control unit 101 to load a program to be executed, as a work area during the execution of the program, or as frame memory of image data to be projected.

(Operation of the Projector)

Next, operation from the time of turning-on of the power to the projector 100 with the above-mentioned configuration onward is described.

When having detected an instruction to turn the power on through the operating unit 102, the control unit 101 instructs the power supply unit 103 to supply power to each block, and also puts each block in a standby state. When the power supply unit 103 has supplied power to each block, the control unit 101 instructs the light source control unit 108 to cause the light source 106 to emit light. Next, the control unit 101 instructs the optical system control unit 109 to adjust the projection optical system 107 on the basis of, for example, the projection distance obtained by the focus detection unit 123 and a projection size obtained by the image pickup unit 124. The optical system control unit 109 drives a focus lens of the projection optical system 107 to perform control in such a manner that an image is formed at the projection distance. Moreover, the optical system control unit 109 drives a magnification lens of the projection optical system 107 to perform control in such a manner as to set the size of a projection image to a predetermined size.

When a video signal input into the video input unit 110 is projected, the video signal undergoes various corrections and scaling by the image processing unit 116 in such a manner as to be an image suitable for display, and is then input as projection image data to the liquid crystal drive unit 105. The liquid crystal drive unit 105 causes the liquid crystal panel of the liquid crystal unit 104 to display the projection image data thereon. The image displayed on the liquid crystal panel of the liquid crystal unit 104 is illuminated with light from the light source 106, and projected by the projection optical system 107 onto the projection surface.

During the projection operation, the control unit 101 monitors a measurement value of the thermometer 119. For example, the control unit 101 operates the cooling unit 120 when the measurement value exceeds a predetermined value, and stops the operation of the cooling unit 120 when the measurement value reduces to or below the predetermined value, and manages the temperature of the light source 106 and the inside of the projector 100.

When having detected an instruction to turn the power off through the operating unit 102, the control unit 101 instructs each block to perform a termination process. The control unit 101 sequentially instructs the power supply unit 103 to terminate the supply of power to blocks that have completed the termination process. The control unit 101 operates the cooling unit 120 until the measurement value of the thermometer 119 reduces to or below a preset temperature and then terminates the supply of power to the cooling unit 120.

(Video Display Operation of the Projector)

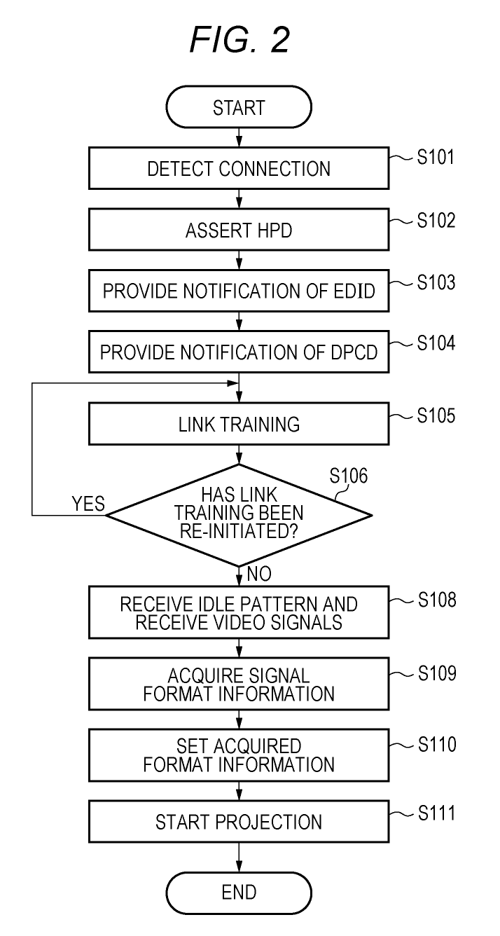

Next, operation from when an external device is connected to the video input unit 110 to when a video signal is projected is further described using a flowchart illustrated in FIG. 2.

In S101, the control unit 101 detects the establishment of a connection between the external device and the video input unit 110 through polling or an interrupt.

In S102, the control unit 101 sets the voltage across a Hot Plug Detect (HPD) pin of the video input unit 110 to a specified value to assert an HPD signal and then notify the external device of the connection. In response to this, the external device transmits an EDID request over the AUX-CH.

In S103, when having received the EDID request from the external device through the video input unit 110 over the AUX-CH, the control unit 101 reads EDID from the EDID storage unit 111. The control unit 101 then notifies the external device of the EDID through the video input unit 110 over the AUX-CH. When having received the EDID from the projector 100, the external device requests values of a receiver capability field of DisplayPort Configuration Data (DPCD) over the AUX-CH.

The DPCD is data included in the video input unit 110, and can be accessed, as a storage area (or register) having a specific address, from the external device over the AUX-CH. The DPCD includes the receiver capability field in which, for example, the transmission rate and the number of transmission lanes, which are supported by a DP receiver, are stored, and a link configuration field in which various setting values are stored. Moreover, the DPCD has a link/sink status field in which information related to a result of link training and the current state of the display apparatus (sink device) is stored.

In S104, when having received a read request of the DPCD (the receiver capability field) from the external device through the video input unit 110 over the AUX-CH, the control unit 101 notifies the external device of the requested data through the video input unit 110 over the AUX-CH.

In the DP standard ver. 1.3, four (Main Link) transmission lanes at the maximum can be used in one-lane, two-lane, or four-lane configuration. Moreover, the transmission rate of each lane can be selected from 1.62 Gbps, 2.7 Gbps, 5.4 Gbps, and 8.1 Gbps. The external device determines a combination of the number of transmission lanes and the transmission rate in accordance with the capability of the projector 100 and a video format (such as resolution, a frame rate, and a color depth) for transmission, which are indicated in the DPCD and the EDID.

The external device then writes a necessary setting value to the link configuration field of the DPCD over the AUX-CH, and transmits a link training pattern through the Main Link to initiate link training. As described above, link training is a procedure for determining the transmission condition of a video data sequence between the external device and the display apparatus.

In S105, link training is performed between the control unit 101 (the video input unit 110) and the external device. In the link training, a training pattern for a clock recovery sequence is transmitted first from the external device. In the video input unit 110, a PLL for clock recovery is locked to the training pattern. If bit lock of a recovered clock is successful, a specific bit indicating the success of clock recovery is set in the DPCD link/sink status field. The external device refers to the DPCD, and when the success of clock recovery can be verified for all lanes used, starts the transmission of a training pattern for a channel equalization sequence.

Channel equalization, symbol boundary detection (symbol lock), and inter-lane alignment are performed in the video input unit 110. When they are successful, specific bits corresponding to individual items in the DPCD link/sink status field are set. The DPCD link/sink status field includes bits indicating the success or failure of clock recovery, channel equalization, symbol synchronization, and inter-lane alignment for each lane.

The channel equalization in the channel equalization sequence includes a procedure in which:

(1) the external device transmits the training pattern for the channel equalization sequence adjusted to levels in accordance with channel equalization parameters (power supply amplitude (voltage-swing) and the level of amplification (pre-emphasis)) as set at the end of the clock recovery sequence;

(2) the video input unit 110 attempts clock recovery on the received training pattern; and

(3) the video input unit 110 determines that the channel equalization is successful when the clock recovery is successful.

When the clock recovery is not successful, the video input unit 110 may request the external device through the DPCD link/sink link configuration field to increase the power supply amplitude (voltage-swing) and the level of amplification (pre-emphasis).

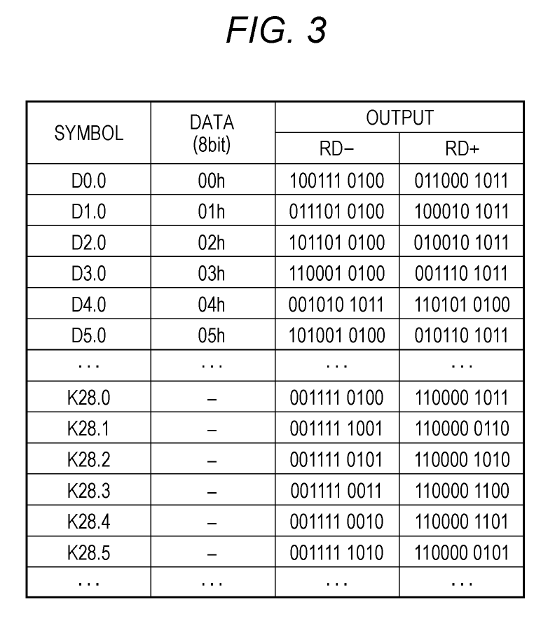

In the DP standard, a video data stream to be transmitted from the external device (source device) to the display apparatus (sink device) includes 8B10B encoded symbols. FIG. 3 illustrates a symbol data table of 8B10B encoding. In 8B10B encoding, symbol data includes a data code Dxx.y (xx ranges from 0 to 31 and y from 0 to 7) corresponding to eight-bit data 00h to FFh, and 12 control codes K28.0 to K28.7, K23.7, K27.7, K29.7, and K30.7. The top five bits of the eight-bit data are 5B6B encoded, and the low three bits are 3B4B encoded to covert the eight-bit data to 10-bit code data.

As illustrated, two types of code data (RD− and RD+) where the polarity (running disparity) is different are assigned to the same symbol. The transmission side selects and outputs one of them to adjust the numbers of zeros and ones in a code string. The type and polarity of code data output immediately before code data to be output next determines the polarity of the next code data. Moreover, the control symbols are used to indicate, for example, a data boundary and an idle state. For example, in the DP standard, K28.5 is inserted into an encoded data stream as a code (called a comma) indicating a data boundary, and is used to detect the symbol boundary (symbol lock) on the receiving apparatus side.

The external device reads the link/sink status field of the DPCD, and determines whether the link training succeeded or failed. If any of the clock recovery, the channel equalization, the symbol lock, and the inter-lane alignment failed in the display apparatus, the external device determines that the link training failed. In this case, the external device changes the transmission condition (at least one of the transmission rate, the number of transmission lanes, and the channel equalization parameters) in accordance with the DP standard, and performs link training again.

Therefore, in S106, the control unit 101 determines whether or not the external device has reinitiated link training and, if determining that link training has been reinitiated, returns the process to S105 and performs link training again from clock recovery. On the other hand, if it is determined that link training succeeded, the external device writes a specific value to a specific address in the link configuration field of the DPCD to provide notification of the termination of the link training. After a predetermined idle pattern periodically including the K28.5 symbol is transmitted, the transmission of a video data stream is started. Therefore, if link training is not initiated on another transmission condition in S106, the video input unit 110 starts receiving the idle pattern and the video data stream from the external device in S108.

In S109, when having detected the receipt of the video data stream through polling or an interrupt, the control unit 101 reads video format information from the video input unit 110. Specifically, the control unit 101 acquires, through the video input unit 110, video attribute information (such as the horizontal and vertical resolutions, the signal format, and the color depth) inserted during the blanking period of the video signal, and stores the attribute information in the RAM 132.

In S110, the control unit 101 sets the horizontal and vertical resolutions included in the read attribute information, in the image processing unit 116. The image processing unit 116 reflects the video resolution in the subsequent image processing. For example, the image processing unit 116 uses the video resolution to calculate a magnification for scaling. Moreover, the image processing unit 116 can use the video resolution to prepare an OSD menu at a resolution where the scaling magnification is considered, when generating a display image on which the OSD menu has been superimposed.

In S111, the control unit 101 executes projection operations (such as control related to the receipt of a video data stream, clock recovery, symbol cut-out processing, decoding, and the generation and display of a display image, and an operation for an instruction through the operating unit 102).

As described above, data transfer in the DP standard does not use a clock signal line. Accordingly, it is required in the display apparatus to recover (generate) a clock from a video data stream received. Hence, the video input unit 110 has a clock recovery function of recovering a clock from data.

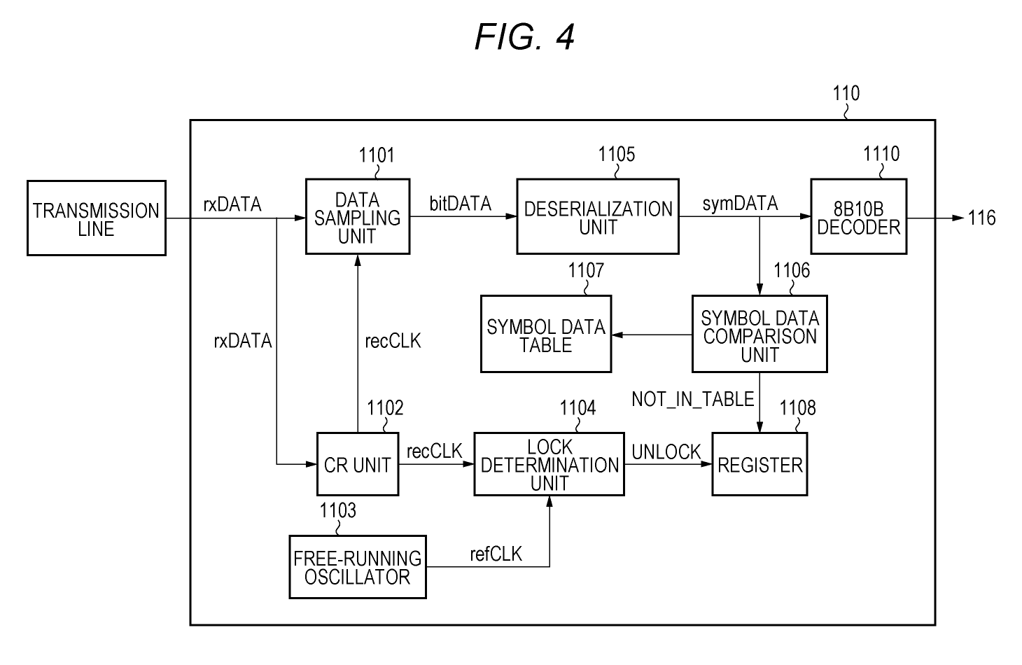

FIG. 4 is a block diagram schematically illustrating the configuration of the video input unit 110. In reality, the configuration illustrated in FIG. 4 is provided for each lane of the Main Link.

A data sampling unit 1101 samples an 8B10B encoded video data stream (rxDATA) received from the external device on the basis of a clock (recCLK) recovered by the clock recovery function, delimiting symbol boundaries in the video data stream. The data sampling unit 1101 outputs the sampled data (bitDATA) to a deserialization unit 1105.

A clock recovery (CR) unit 1102 is a phase locked loop (PLL) including a phase comparator and a voltage-controlled oscillator (VCO). The CR unit 1102 further includes a variable frequency divider, and can generate a signal obtained by multiplying the oscillation frequency of the VCO. The oscillation frequency of the VCO is controlled on the basis of rxDATA from the external device to lock the PLL to (signal rising and falling) edges of rxDATA. Accordingly, the clock is recovered (generated). The CR unit 1102 supplies the recovered clock (recCLK) to the data sampling unit 1101 and a lock determination unit 1104. When the transmission rate of rxDATA changes, the PLL also tracks it and the frequency of recCLK also changes. However, if the transmission rate of rxDATA exceeds the range of lock frequencies of the PLL, the PLL is unlocked and accordingly it becomes impossible to bit lock to rxDATA (clock recovery fails).

For example, if rxDATA has been transmitted at a transmission rate exceeding a bandwidth determined by link training, the PLL can be unlocked to fail in clock recovery. Take a specific example. If a video signal where the effective resolution is 4096 pixels×2160 pixels, the vertical frequency is 60 Hz, and the color depth is 8 bits/pixel is transmitted, a transmission bandwidth including an overhead in 8B10B encoding is 20.878 Gbps. This value is based on Coordinated Video Timings (CVT) 1.2 issued by Video Electronics Standards Association (VESA). It is assumed, for example, that as a result of link training, the external device has determined to use four lanes with a transmission rate of 5.4 Gbps (21.6 Gbps bandwidth). However, in reality, if the color depth of a video signal transmitted from the external device is 12 bits/pixel, a required transmission bandwidth is 25.053 Gbps according to CVT 1.2, which exceeds the bandwidth determined by the link training. In this case, the PLL of the video input unit 110 cannot track it and can be unlocked.

A free-running oscillator 1103 is an oscillator that outputs a reference clock (refCLK) used to determine whether or not the PLL of the CR unit 1102 has been locked (whether or not the recovered clock is in bit synchronization with rxDATA). The free-running oscillator 1103 supplies the reference clock to the lock determination unit 1104.

The lock determination unit 1104 is a counter circuit that determines whether the PLL of the CR unit 1102 is in a locked state or unlocked state (whether the clock recovery succeeded or failed) on the basis of the recovered clock from the CR unit 1102 and the reference clock from the free-running oscillator 1103. If determining that the PLL is in the unlocked state (the clock recovery failed), the lock determination unit 1104 outputs an UNLOCK signal to a register 1108. If, for example, recCLK/refCLK is different from a predetermined counter value (for example, a counter value at the time of the link training), the lock determination unit 1104 determines it to be the unlocked state. The output of the UNLOCK signal may be an operation of setting a bit (called an UNLOCK bit) assigned to the UNLOCK signal in the register 1108, and an operation of clearing the bit indicating the success of clock recovery.

As described above, in the channel equalization sequence in link training, it is necessary to set or clear a register (bit) indicating a result of channel equalization on the basis of success or failure of clock recovery attempted for a training pattern with a signal whose level has been adjusted by the external device for the channel equalization. The lock determination unit 1104 sets or clears the bit in the register 1108, the bit indicating a result of the clock recovery sequence or the channel equalization sequence in the link training, on the basis of the sequence.

The deserialization unit 1105 converts serial data supplied from the data sampling unit 1101 to 10-bit parallel symbol data (symDATA). The deserialized symbol data is supplied to an 8B10B decoder 1110. The 8B10B decoder 1110 decodes the 10-bit parallel symbol data to 8-bit video data and outputs the 8-bit video data to the image processing unit 116.

A symbol data table 1107 stores the symbol data table described with FIG. 3. A symbol data comparison unit 1106 checks whether or not symDATA output by the deserialization unit 1105 is present in the symbol data table 1107. If symDATA is not present in the symbol data table 1107, it indicates that data could not be sampled at a right timing (symbol lock failed). Hence, the symbol data comparison unit 1106 outputs a NOT_IN_TABLE signal to the register 1108. Alternatively, the symbol data comparison unit 1106 may set a bit (called a NOT_IN_TABLE bit), assigned to the NOT_IN_TABLE signal, of the register 1108.

The output of the NOT_IN_TABLE signal may be an operation of clearing the bit indicating the success of symbol lock in the register 1108. On the other hand, if symDATA is present in the symbol data table 1107, symbols could be extracted properly from the received video data stream (a symbol locked state). Accordingly, the symbol data comparison unit 1106 does not output the NOT IN TABLE signal.

The register 1108 is a storage device (for example, a latch circuit) where a determination result of the lock determination unit 1104 and a comparison result of the symbol data comparison unit 1106 are stored. A part (the link/sink status field) of the DPCD for retaining results of clock recovery, symbol boundary detection, and the like at the time of link training in the DP standard may be used as the register 1108. The link/sink status field of the DPCD is provided for the external device to check the state of the display apparatus at the time of link training, and is not particularly used after the link training. Hence, the link/sink status field of the DPCD can be used to retain the determination result of the lock determination unit 1104 and the comparison result of the symbol data comparison unit 1106.

In the embodiment, even after the link training is terminated and the receipt of the video data stream is started, the lock determination unit 1104 and the symbol data comparison unit 1106 continually determine whether clock recovery succeeded or failed and whether symbol lock succeeded or failed to reflect the determination results on the register 1108. The control unit 101 refers to the register 1108 of the video input unit 110 and accordingly can find the success or failure of clock recovery (whether it is a bit locked or unlocked state) from the video data stream (rxDATA) and the success or failure of symbol lock (whether it is a locked or unlocked state).

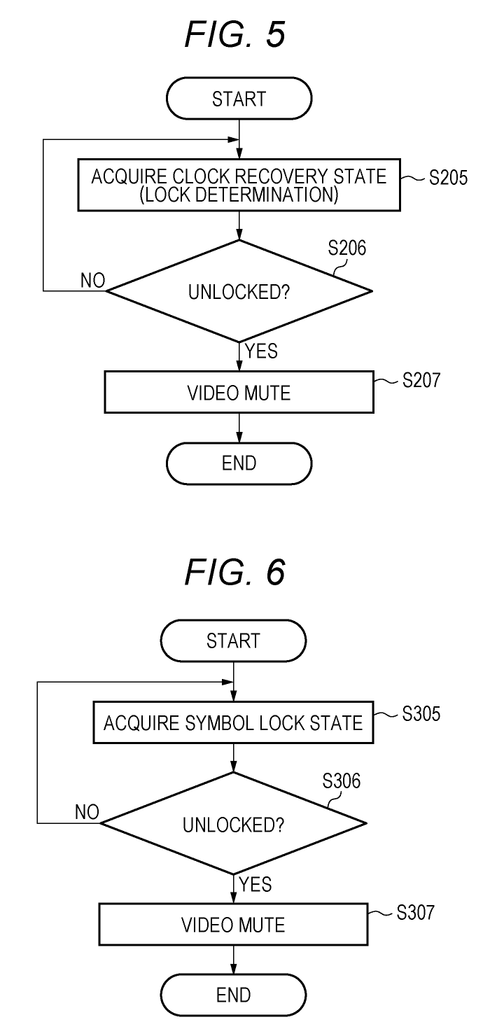

The transmission rate and the number of transmission lanes are determined by the link training. When the receipt of the video data stream has been started, the video input unit 110 starts clock recovery, and data sampling based on a recovered clock and a detected data boundary (S108 of FIG. 2). The lock determination unit 1104 and the symbol data comparison unit 1106 continuously repeat the determination operation to always reflect the determination results on the register 1108. The control unit 101 then executes a monitoring operation illustrated in a flowchart of FIG. 5 while executing S109 and the subsequent steps of FIG. 2.

In S205, the control unit 101 reads the UNLOCK bit in the register 1108. In S206, the control unit 101 then determines whether or not the read bit indicates the failure of clock recovery and, if determining that the read bit indicates failure, advances the process to S207. If the UNLOCK bit of the register 1108 is set, the control unit 101 determines that it indicates the failure of clock recovery. If the register 1108 is the DPCD, the control unit 101 reads the bit indicating the success or failure of clock recovery and, if the bit is cleared, determines that it indicates the failure of clock recovery. The control unit 101 returns the process to S205 after, for example, a fixed period of time unless it is determined that the read bit indicates the failure of clock recovery. Moreover, clock recovery is performed for each lane. Accordingly, the UNLOCK bit is also present for each lane. If a plurality of lanes is used, the control unit 101 advances the process to S207 if there is even one lane where clock recovery failed.

In S207, the control unit 101 instructs the image processing unit 116 to mute the video. In response to the instruction of video mute, the image processing unit 116 outputs, to the liquid crystal drive unit 105, not an image based on the received video data but a predetermined image (for example, an image whose entire surface is of the same color). Consequently, it is possible to prevent distorted video from being displayed. The image displayed at the time of video mute may contain, for example, a message that prompts the check of the connection or a reconnection to the external device.

In this manner, the control unit 101, for example, periodically reads the UNLOCK bit of the register 1108 to check whether clock recovery succeeded or failed and, if the failure of clock recovery is detected, starts video mute. If the success of clock recovery is detected, the video mute process is not performed.

It is assumed that the UNLOCK bit of the register 1108 is read by the control unit 101 and then the retained data is reset to always reflect the latest determination result.

It is configured here in such a manner that when having detected the failure of clock recovery, the control unit 101 immediately instructs the image processing unit 116 to mute the video. However, for example, it is may be configured in such a manner as to give an instruction to mute the video at the point in time when the failure of clock recovery is detected a predetermined plurality of times in a row. Furthermore, the control unit 101 may notify a user of the receipt of an illegal signal through, for example, an on screen display (OSD), in addition to the instruction of video mute.

Furthermore, in the embodiment, the configuration that is compliant with the DisplayPort standard has been described. However, received data is 8B10B encoded. However, the configuration of the embodiment does not depend on a specific encoding format as long as a clock can be generated from received data. It may be, for example, received data encoded in a clock embedded format such as 10B12B, 64B66B, 64B67B, or 128B130B. Therefore, an interface standard for an external device is not limited to the DisplayPort standard, either.

As described above, according to the embodiment, it is determined whether clock recovery from video data stream data received from an external device succeeded or failed. When the failure of clock recovery is detected at least once, video mute is started. Hence, even when clock recovery fails due to, for example, the transmission of data with a bandwidth exceeding the receiving capability of a display apparatus, the display apparatus can take a measure to prevent distorted video from being displayed. Especially in a display apparatus that is compliant with the DisplayPort standard, the DPCD used for link training can be diverted as an area where information indicating the success or failure of clock recovery is stored; accordingly, it is useful.

(Modification)

Next, a modification of the first embodiment is described. The first embodiment has the configuration to prevent disordered display by detecting the failure of clock recovery during receipt of a video data stream and switching a display image. However, it may be configured in such a manner that the above-mentioned symbol data comparison unit 1106 switches a display image when having detected the failure of symbol lock. Even in the case where clock recovery is successful, naturally including the case where clock recovery fails, when symbol lock is not achieved, correct data cannot be received. Accordingly, it becomes a cause of distorted display. Symbol lock can fail due to, for example, the performance of the data sampling unit 1101 or the quality of a transmission line.

Therefore, the switching of the display screen upon detection of the failure of symbol lock enables the prevention of distorted display, not limited to when clock recovery fails due to the failure of symbol lock.

FIG. 6 is a flowchart of the monitoring operation to be executed by the control unit 101 in parallel with image display after the link training is terminated and then the receipt of a video data stream is started. As in FIG. 5 of the first embodiment, the control unit 101 executes the monitoring operation in parallel with S109 and the subsequent steps of FIG. 2.

Next, in S305, the control unit 101 refers to the register 1108, and determines whether symbol lock succeeded or failed. The control unit 101 reads the NOT_IN_TABLE bit of the register 1108. The control unit 101 then determines that symbol lock failed (the symbol unlocked state) if the NOT_IN_TABLE bit is set. If the register 1108 is the DPCD, the control unit 101 reads the bit indicating the success or failure of symbol lock and, if the bit is cleared, determines it to be the symbol unlocked state. The control unit 101 advances the process to S307 if it has been determined to be the symbol unlocked state, and returns the process to S305 after, for example, a fixed period of time if it has not been determined to be the symbol unlocked state.

In S307, the control unit 101 instructs the image processing unit 116 to mute the video. In response to the instruction of video mute, the image processing unit 116 outputs, to the liquid crystal drive unit 105, not an image based on the received video data but a predetermined image (for example, an image whose entire surface is of the same color). Consequently, it is possible to prevent distorted video from being displayed. The image displayed at the time of video mute may contain, for example, a message that prompts the check of the connection or a reconnection to the external device.

In this manner, the control unit 101, for example, periodically refers to the register 1108 to check whether symbol lock succeeded or failed and, if it is in the locked state, does not perform the video mute process and, if it is in the unlocked state, performs the video mute process. It is assumed that the NOT_IN_TABLE bit of the register 1108 is read by the control unit 101, and then the retained data is reset.

Here, when having detected the failure of symbol lock (the unlocked state), the control unit 101 immediately instructs the image processing unit 116 to mute the video. However, for example, it may be configured to give an instruction to mute the video at the point in time when the failure of symbol lock is detected a predetermined plurality of times in a row. Furthermore, the control unit 101 may notify a user of the receipt of an illegal signal through, for example, an on screen display (OSD), in addition to the instruction of video mute.

Moreover, symbol data to be compared is not limited here. However, for example, a comparison may be made to find whether or not symDATA contains a predetermined code (such as the K28.5 comma code) that is always included in a received video data stream. Furthermore, the success or failure of symbol lock may be determined from a change in the polarity of the running disparity of symDATA output from the deserialization unit 1105. For example, if there is a run of the same polarity, recCLK may drift. Therefore, when a run of the same polarity is detected, the symbol data comparison unit 1106 may determine that symbol lock failed. Alternatively, the register 1108 may be provided with a bit indicating the presence or absence of a running disparity error.

The bit indicating the success or failure of the channel equalization process specified in the DP standard can also be used as in the bit indicating the success or failure of symbol lock.

In the modification, the success or failure of symbol lock is determined from a comparison of sampled symbol data (symDATA) and specified symbol data. If it is determined that symbol lock failed, video is muted. Moreover, also if it is determined that channel equalization failed, video is muted. In the modification, it is also possible for a display apparatus to detect a state where a display is distorted for reasons other than the failure of clock recovery and take a measure to prevent distorted video from being displayed. Moreover, in a display apparatus that is compliant with the DisplayPort standard, the DPCD used for link training can be diverted as an area where information indicating the success or failure of symbol lock and channel equalization is stored; accordingly, it is useful.

### Second Embodiment

Next, a second embodiment of the present disclosure is described. The embodiment is characterized in that when clock recovery fails, a transmission condition is changed on a display apparatus side, and then link training is performed to change the transmission condition to a transmission condition corresponding to a transmission bandwidth of a video data stream from an external device.

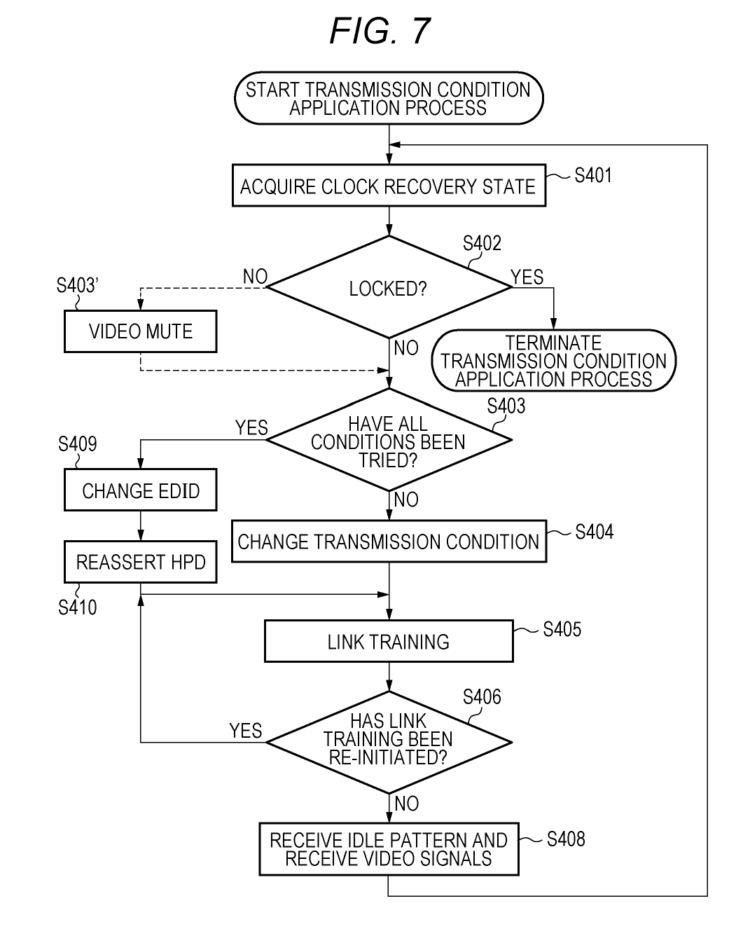

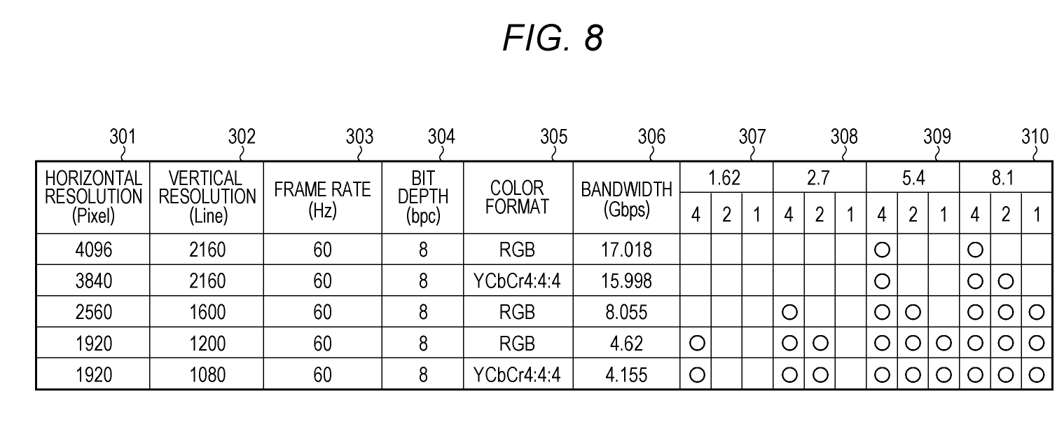

Specifically, after link training is terminated and then the receipt of a video data stream is started, the control unit 101 executes a transmission condition application process. The details of the transmission condition application process are described using FIGS. 7 and 8.

It is assumed here that the sharing of the EDID and the link training are complete, and a video format has an effective resolution of 4096 pixels×2160 pixels, a vertical frequency of 60 Hz, and a color depth of 8 bits/pixel. Moreover, it is assumed that as a result of the link training, the external device determined that the number of transmission lanes is four, and the transmission rate is 8.1 Gbps. It is assumed, however, that the external device has transmitted the video data stream at a transmission rate exceeding 8.1 Gbps per lane due to malfunction.

The control unit 101 reads the UNLOCK bit of the register 1108 in S401, and determines whether clock recovery succeeded or failed in S402. If having determined that clock recovery succeeded (it is the locked state), the control unit 101 maintains the condition at the time of the initial link training (performed in S105) to terminate the transmission condition application process.

On the other hand, if having determined that clock recovery failed (it is the unlocked state), the control unit 101 temporarily interrupts the projection process to advance the process to S403. As indicated as S403′, the video mute process may be executed at this point in time.

In the process in S403 and the subsequent steps, the control unit 101 executes control in such a manner as to change the transmission condition on the transmission rate, the number of transmission lanes, and the like for the external device, on the basis of the information retained by the projector 100 in the EDID storage unit 111 and the internal memory 115.

FIG. 8 illustrates a table illustrating video formats supported by the projector 100 by transmission condition. The table retains a horizontal resolution 301, a vertical resolution 302, a frame rate 303, a bit depth 304, and a color format 305 (including a pixel encoding format). Moreover, the table also includes a bandwidth 306 required to transmit each video format. Items 307 to 310 indicate correspondences between a combination of the transmission rate per lane and the numbers of transmission lanes and the video format. ◯ indicates support. In the table, the items 301 to 305 are retained in the EDID storage unit 111 of the projector 100 and the items 306 to 310 in the internal memory 115. The control unit 101 can read these pieces of information via the bus 133.

In S403, the control unit 101 determines whether or not all the transmission conditions supporting the received video format (the conditions to which ◯ is assigned in the table of FIG. 8) have been tried. If determining that all the conditions have been tried, the control unit 101 advances the process to S409. If determining that all the conditions have not been tried, the control unit 101 advances the process to S404. The control unit 101 can make a determination by, for example, retaining information indicating a tried condition in the RAM 132, and making a comparison with the table. Alternatively, the control unit 101 may retain, in the RAM 132, information indicating all the transmission conditions that need to be tried for the first try and delete information corresponding to a tried condition. Information indicating a transmission condition determined by the link training in S105 is not retained in the RAM 132. In this case, in S403, the control unit 101 can determine that there is an untried transmission condition if information indicating a transmission condition remains in the RAM 132.

In S404, the control unit 101 selects one of untried transmission conditions, except the transmission condition determined by the link training in S105, and executes a process of changing the transmission condition. Only the remaining transmission condition supporting the format where the effective resolution is 4096 pixels×2160 pixels, the vertical frequency is 60 Hz, and the color depth is 8 bits/pixel is a combination of a transmission rate of 5.4 Gbps, and four transmission lanes. The control unit 101 saves information indicating this transmission condition in the RAM 132, and performs the transmission condition change process. Specifically, the control unit 101 changes the values of the maximum transmission rate (MAX_LINK_RATE) and the maximum number of transmission lanes (MAX_LINK_COUNT) of the receiver capability field of the DPCD, according to the changed transmission condition, to change the transmission condition. In this example, the control unit 101 does not change the maximum number of transmission lanes but changes the maximum transmission rate from 8.1 Gbps to 5.4 Gbps.

In S405, the control unit 101 performs a procedure for performing link training specified in the DP standard again (for example, a notice using an HPD signal), and prompts the external device to perform link training again. The external device reads the receiver capability field of the DPCD to perform link training. Accordingly, the link training in S405 is performed on the basis of the changed transmission condition.

The external device reads the link/sink status field of the DPCD, and determines whether the link training succeeded or failed. If determining that the link training failed, the external device changes the transmission condition in accordance with the DP standard and then performs link training again.

Therefore, in S406, the control unit 101 determines whether or not the external device has reinitiated link training. If determining that link training has been initiated, the control unit 101 returns the process to S405 to execute operations related to the link training again. On the other hand, if determining that the link training succeeded, the external device writes a specific value to a specific address in the link configuration field of the DPCD to provide notification of the termination of the link training.

When the link training is successful, the control unit 101 receives the idle pattern and the subsequent video data stream in S408, returns the process to S401, and determines whether clock recovery succeeded or failed. If the success of clock recovery can be verified in S402, the control unit 101 terminates the process (video mute is also terminated if applicable), and resumes the process of S109 and the subsequent steps of FIG. 2.

If the connection to the external device is subsequently cut due to, for example, an instruction to turn the power off to the projector 100 or the disconnection of a cable connected to the external device, the control unit 101 returns the maximum transmission rate and the maximum number of transmission lanes of the receiver capability field of the DPCD to the original ones.

Next, a process in a case where it is determined in S403 that all the conditions have been tried is described. As described above, in the embodiment, the display apparatus forces link training, and the transmission capability of the display apparatus is reduced in such a manner that a transmission condition where the bandwidth is reduced by the link training is determined, of which the external device is notified. As a result, link training is repeated in such a manner that a transmission condition with a bandwidth reduced as compared to the current transmission condition is determined, whenever the failure of clock recovery or the like is detected in S401. However, a case is also conceivable in which receipt cannot be achieved normally even on a transmission condition with a minimum bandwidth required among transmission conditions supporting the video format.

In such a case, in S409, the control unit 101 changes the EDID in the EDID storage unit 111. Specifically, the control unit 101 makes a change in such a manner as to provide notification of a video format where the transmission bandwidth is reduced as compared to the current bandwidth (for example, the effective resolution is reduced, or the color depth is reduced) as the video format supported by the display apparatus. The control unit 101 rewrites to a value corresponding to a video format to be tried next in an area (a Detailed Timing Descriptor) where timing information is described, the area being included in the EDID. Alternatively, the control unit 101 may change video format information using the DisplayID format specified by VESA as an extension block of the EDID.

In the example of the embodiment, S409 is executed if receipt cannot be achieved normally even on a condition where the minimum bandwidth is required among transmission conditions supporting the video format where the effective resolution is 4096 pixels×2160 pixels, the vertical frequency is 60 Hz, and the color depth is 8 bits/pixel. Therefore, the control unit 101 changes, for example, the effective resolution described in the EDID to 3840 pixels×2160 pixels.

When the rewrite is complete, the control unit 101 reasserts an HDP signal in S410 to prompt the external device to share the EDID again. After the EDID is shared, the control unit 101 reads the receiver capability field of the DPCD in response to a request of the external device, and notifies the external device through the video input unit 110 over the AUX-CH. The contents of the receiver capability field of the DPCD remain the same as the transmission condition before the effective resolution was reduced (here, a maximum transmission rate of 5.4 Gbps and four transmission lanes at the maximum), which was tried for the video format of 4096 pixels×2160 pixels. Hence, the control unit 101 returns the transmission condition to the original one (a maximum transmission rate of 8.1 Gbps and four transmission lanes at the maximum) at least before reasserting the HPD signal.

After this operation, link training is performed in S405. In S408, the receipt of the video data stream is started on a transmission condition corresponding to the condition where the maximum resolution is 3840 pixels×2160 pixels. It is assumed here that the transmission rate is determined to be 8.1 Gbps and the number of lanes to be four. If it is determined in S402 that clock recovery succeeded, the control unit 101 resumes the process in S109 of FIG. 2.

On the other hand, if it is determined that clock recovery failed, the control unit 101 selects an untried transmission condition among the transmission conditions supporting the video format of 3840 pixels×2160 pixels with the vertical frequency of 60 Hz, and the color depth of 8 bits/pixel, in S404. The control unit 101 rewrites the DPCD in such a manner that link training occurs on the selected transmission condition, and notifies the external device using the HPD signal.

In S404, the untried condition to be tried first by the control unit 101 is either the transmission rate 5.4 Gbps and four transmission lanes or the transmission rate 8.1 Gbps and two transmission lanes. However, the transmission condition having a higher number of transmission lanes is tried first here. This is because when the external device transmits a video data stream on more lanes than the number determined by link training, the display apparatus side may not be able to recognize it.

From this point on, the control unit 101 changes the transmission condition to untried transmission conditions in sequence and repeats the process of S404 and the subsequent steps until it is determined in S402 that clock recovery succeeded, as described above.

As described above, according to the embodiment, if clock recovery fails after link training, the display apparatus side prompts the external device to initiate (perform again) link training. At this point in time, the transmission capability of the display apparatus side is reduced, of which the external device is notified. Accordingly, next time link training is performed, it is possible to increase the possibility to determine a transmission condition with a reduced bandwidth, which allows stable receipt. In this manner, the display apparatus side substantially controls the transmission condition. Accordingly, even if a video data stream cannot be received properly due to, for example, the external device or the quality of a transmission line, it becomes possible to prevent a display from being continually distorted and return quickly to a normal display.

Moreover, if clock recovery does not succeed even after change of the transmission condition, the display apparatus side changes EDID, reduces the display capability of the display apparatus, and notifies the external device when the display apparatus side prompts the external device to initiate (perform again) link training. Hence, next time link training is performed, it is possible to increase the possibility to determine a transmission condition with a reduced bandwidth, which allows stable receipt.

In the embodiment, the configuration to monitor the failure of clock recovery has been described. However, as in the first embodiment, the failure of symbol lock and channel equalization may be monitored.

### Other Embodiments

One or more embodiments of the present disclosure can also be realized by a process of supplying a program that achieves one or more functions of the above-mentioned embodiments to a system or apparatus via a network or storage medium, and causing one or more processors in a computer of the system or apparatus to read and execute the program. Moreover, one or more embodiments of the present disclosure can also be realized by a circuit (for example, an ASIC) that achieves one or more functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-220902, filed Nov. 11, 2016, which is hereby incorporated by reference herein in its entirety.

What is claimed is:

1. A display apparatus, compliant with the DisplayPort standard, that performs link training for determining a transmission condition of a video data stream, with an external device that outputs the video data stream,
the link training including clock recovery, symbol lock, and channel equalization for the video data stream received from the external device, the display apparatus comprising:
a detection unit configured to, during receipt of the video data stream from the external device after the transmission condition is determined by the link training, detect failure of any of the clock recovery, the symbol lock, and the channel equalization for the video data stream.

2. The display apparatus according to claim 1, further comprising a control unit configured to display a predetermined image instead of an image based on the video data stream upon the detection unit having detected the failure of any of the clock recovery, the symbol lock, and the channel equalization for the video data stream.

3. The display apparatus according to claim 1, wherein the detection unit refers to information indicating results of the clock recovery, the symbol lock, and the channel equalization to detect the failure.

4. The display apparatus according to claim 3, wherein the information is accessible from the external device.

5. The display apparatus according to claim 3, wherein the information is DisplayPort Configuration Data (DPCD).

6. The display apparatus according to claim 1, wherein upon the video data stream having been encoded with symbols having polarities and a change in the polarity of a symbol obtained from the video data stream not satisfying a predetermined condition, it is determined that the symbol lock failed.

7. The display apparatus according to claim 1, wherein upon a symbol obtained from the video data stream being not a symbol used for encoding the video data stream, it is determined that the symbol lock failed.

8. The display apparatus according to claim 1, further comprising a changing unit configured to, upon the failure having been detected, notify the external device of a transmission capability lower than a current transmission condition and change the transmission condition of the video data stream.

9. The display apparatus according to claim 8, wherein the changing unit changes information on the display apparatus, the information being accessible from the external device, to notify the external device of the transmission capability lower than the current transmission condition.

10. The display apparatus according to claim 9, wherein the information on the display apparatus is DisplayPort Configuration Data (DPCD).

11. The display apparatus according to claim 1, further comprising a changing unit configured to, upon the failure having been detected, notify the external device of a video format having a reduced transmission bandwidth as compared to a current transmission bandwidth, as a video format supported by the display apparatus, and accordingly change the transmission condition of the video data stream.

12. The display apparatus according to claim 11, wherein the changing unit changes information on the display apparatus, the information being accessible from the external device, to notify the external device of a transmission capability lower than a current transmission condition.

13. The display apparatus according to claim 12, wherein the information on the display apparatus is Extended Display Identification Data (EDID).

14. The display apparatus according to claim 1, wherein upon clock recovery for a training pattern transmitted at an adjusted level being successful, it is determined that the channel equalization succeeded.

15. A method for controlling a display apparatus, compliant with the DisplayPort standard, that performs link training for determining a transmission condition of a video data stream, with an external device that outputs the video data stream,
the link training including clock recovery, symbol lock, and channel equalization for the video data stream received from the external device, the method comprising:
during receipt of the video data stream from the external device after the transmission condition is determined by the link training, detecting failure of any of the clock recovery, the symbol lock, and the channel equalization for the video data stream.

16. A display apparatus comprising:
a generation unit configured to generate a clock from a data stream received from an external device;
an extraction unit configured to extract symbol data from the data stream at a timing based on the clock;
an output unit configured to output a display image based on the data stream;
a detection unit configured to detect failure of any of bit lock of the clock by the generation unit, symbol lock by the extraction unit, and channel equalization, for the data stream received from the external device; and
an instruction unit configured to instruct the output unit to change the display image to a predetermined image in response to the detection.

17. A method for controlling a display apparatus comprising:
generating a clock from a data stream received from an external device;
extracting symbol data from the data stream at a timing based on the clock;
outputting a display image based on the data stream;
detecting failure of any of bit lock of the clock in the generation step, symbol lock in the extraction step, and channel equalization, for the data stream received from the external device; and
changing the display image output in the output step to a predetermined image in response to the detection.
